(19) United States
(12) Patent Application Publication
(10) Pub. No.: US 2026/0296055 A1
(43) Pub. Date: Oct. 1, 2026

(54) INKJET RECORDING APPARATUS

(71) Applicant: KYOCERA CORPORATION, Kyoto-shi, Kyoto (JP)

(72) Inventor: Yuki TAMURA, Suita-shi, Osaka (JP)

(21) Appl. No.: 19/480,365

(22) PCT Filed: May 21, 2024
(86) PCT No.: PCT/JP2024/018635

§ 371 Date: Oct. 31, 2025

(30) Foreign Application Priority Data
May 30, 2023 (JP) 2023-089098

(51) Int. Cl. B41J 3/407; B41J 2/21; B41J 11/00

(52) U.S. Cl. CPC B41J 3/4078; B41J 2/2103; B41J 2/2114; B41J 11/0015; B41J 11/007

(57) ABSTRACT

In an inkjet recording apparatus, a distance between a center of an ejection area in a pretreatment head in a feed direction and a position of an axis of an upstream support roller is a first reference distance, and a distance between a center of an ejection area in a post-treatment head in the feed direction and a position of an axis of a downstream support roller is a second reference distance. One of the reference distances (the second reference distance in FIG. 7) for the pretreatment head or the post-treatment head to eject a smaller amount of liquid (the post-treatment head in FIG. 7) is shorter than another of the reference distances (the first reference distance in FIG. 7) for the pretreatment head or the post-treatment head to eject a larger amount of liquid.

### RELATED APPLICATIONS

The present application is a National Phase of International Application No. PCT/JP2024/018635 filed May 21, 2024, which claims priority to Japanese Application No. 2023-089098, filed May 30, 2023.

### TECHNICAL FIELD

The present disclosure relates to an inkjet recording apparatus.

BACKGROUND OF INVENTION An inkjet recording apparatus such as an inkjet printer includes an ink head that ejects ink droplets for image formation onto a recording medium. When the recording medium is, for example, a fabric sheet such as a woven fabric sheet or a knitted fabric sheet or a plastic sheet, a pretreatment liquid or a post-treatment liquid may be applied to the recording medium before and after the ejection of ink droplets onto the recording medium. The pretreatment liquid improves, for example, the fixation of ink droplets on the recording medium or facilitates agglomeration of ink pigments. The post-treatment liquid, for example, improves the toughness of printed images. In this case, the inkjet recording apparatus includes, in addition to an ink head, treatment heads for ejecting droplets of the pretreatment liquid and the post-treatment liquid.

The ink head and the treatment heads each include multiple ejection orifices that eject droplets of a liquid to be ejected from each of the heads, and an ejection surface in which the multiple ejection orifices are open.

In a recording process, a feeding assembly feeds the recording medium in a predetermined feed direction, and the ink head and the treatment heads eject droplets of ink and the treatment liquids through the ejection orifices.

The feeding assembly includes an endless feed belt facing the ink head and the treatment heads, a drive roller, and a follower roller.

The drive roller and the follower roller are spaced from each other in the feed direction. The feed belt includes a feeding surface facing the ink head with a space between the feeding surface and an area of the ink head through which the ink droplets are ejected. The feed belt wound around the drive roller and the follower roller rotates to feed the recording medium on the feeding surface in the feed direction.

### SUMMARY

In one aspect of the present disclosure, an inkjet recording apparatus includes a head group, a feed belt, a pair of rollers, and an upstream support roller and a downstream support roller. The head group includes an ink head, a pretreatment head, and a post-treatment head. The ink head includes an ejection area through which an ink liquid is ejected. The pretreatment head includes an ejection area through which a pretreatment liquid is ejected. The post-treatment head includes an ejection area through which a post-treatment liquid is ejected. The feed belt includes a feeding surface facing the ejection areas in the head group with a space between the feeding surface and the ejection areas. The feed belt is rotatable in a feed direction to feed a recording medium on the feeding surface in the feed direction. The pair of rollers are rollers around which the feed belt is wound. The pair of rollers are spaced from each other in the feed direction. The upstream support roller and the downstream support roller are aligned in the feed direction between the pair of rollers and support the feed belt from inside the feed belt. The pretreatment head, the ink head, and the post-treatment head are arranged in an order of the pretreatment head, the ink head, and the post-treatment head from upstream to downstream in the feed direction. One of a first reference distance or a second reference distance for the pretreatment head or the post-treatment head to eject a smaller amount of liquid is shorter than another of the first reference distance or the second reference distance for the pretreatment head or the post-treatment head to eject a larger amount of liquid, where the first reference distance is a distance in the feed direction between a center of the ejection area in the pretreatment head in the feed direction and a position of an axis of the upstream support roller, and the second reference distance is a distance in the feed direction between a center of the ejection area in the post-treatment head in the feed direction and a position of an axis of the downstream support roller.

In another aspect of the present disclosure, an inkjet recording apparatus includes a head group, a feed belt, a pair of rollers, and an upstream support roller and a downstream support roller. The head group includes an ink head, a pretreatment head, and a post-treatment head. The ink head includes an ejection area through which an ink liquid is ejected. The pretreatment head includes an ejection area through which a pretreatment liquid is ejected. The post-treatment head includes an ejection area through which a post-treatment liquid is ejected. The feed belt includes a feeding surface facing the ejection areas in the head group with a space between the feeding surface and the ejection areas. The feed belt is rotatable in a feed direction to feed a recording medium on the feeding surface in the feed direction. The pair of rollers are rollers around which the feed belt is wound. The pair of rollers are spaced from each other in the feed direction. The upstream support roller and the downstream support roller are aligned in the feed direction between the pair of rollers and support the feed belt from inside the feed belt. The pretreatment head, the ink head, and the post-treatment head are arranged in an order of the pretreatment head, the ink head, and the post-treatment head from upstream to downstream in the feed direction. The post-treatment head ejects a smaller amount of liquid than the pretreatment head. A distance in the feed direction between a center of the ejection area in the pretreatment head in the feed direction and a position of an axis of the upstream support roller is equal to a distance in the feed direction between a center of the ejection area in the post-treatment head in the feed direction and a position of an axis of the downstream support roller. When viewed in a direction perpendicular to the feeding surface of the feed belt, the ejection area in the post-treatment head is entirely located in an inter-roller area on the feed belt between a contact line with the upstream support roller and a contact line with the downstream support roller.

In another aspect of the present disclosure, an inkjet recording apparatus includes a head group, a feed belt, a pair of rollers, and an upstream support roller and a downstream support roller. The head group includes an ink head, a pretreatment head, and a post-treatment head. The ink head includes an ejection area through which an ink liquid is ejected. The pretreatment head includes an ejection area through which a pretreatment liquid is ejected. The post-treatment head includes an ejection area through which a post-treatment liquid is ejected. The feed belt includes a feeding surface facing the ejection areas in the head group with a space between the feeding surface and the ejection areas. The feed belt is rotatable in a feed direction to feed a recording medium on the feeding surface in the feed direction. The pair of rollers are rollers around which the feed belt is wound. The pair of rollers are spaced from each other in the feed direction. The upstream support roller and the downstream support roller are aligned in the feed direction between the pair of rollers and support the feed belt from inside the feed belt. The pretreatment head, the ink head, and the post-treatment head are arranged in an order of the pretreatment head, the ink head, and the post-treatment head from upstream to downstream in the feed direction. The pretreatment head ejects a smaller amount of liquid than the post-treatment head. A distance in the feed direction between a center of the ejection area in the pretreatment head in the feed direction and a position of an axis of the upstream support roller is equal to a distance in the feed direction between a center of the ejection area in the post-treatment head in the feed direction and a position of an axis of the downstream support roller. When viewed in a direction perpendicular to the feeding surface of the feed belt, the ejection area in the pretreatment head is entirely located in an inter-roller area on the feed belt between a contact line with the upstream support roller and a contact line with the downstream support roller.

### BRIEF DESCRIPTION OF THE DRAWINGS

FIG. 1 is a perspective view of an inkjet printer (inkjet recording apparatus) according to a first embodiment, illustrating its overall structure.

FIG. 2 is a schematic cross-sectional view taken along section line II-II in FIG. 1.

FIG. 3 is an enlarged side view of a carriage mounted portion in the inkjet printer as viewed from the left.

FIG. 4 is a side view of a support structure of a downstream support roller at its left end, including a partial section.

FIG. 5 is a schematic plan view of a carriage as viewed from above.

FIG. 6 is a schematic plan view of an ejection surface of an ink head, a pretreatment head, or a post-treatment head.

FIG. 7 is a plan view of the heads mounted on the carriage, an upstream support roller, and a downstream support roller, illustrating their positional relationships.

FIG. 8 is a diagram illustrating a variation of the first embodiment, corresponding to FIG. 7.

FIG. 9 is diagram illustrating a second embodiment, corresponding to FIG. 7.

FIG. 10 is a diagram illustrating a variation of the second embodiment, corresponding to FIG. 9 (or FIG. 7).

FIG. 11 is a diagram illustrating another embodiment, corresponding to FIG. 6.

### DESCRIPTION OF EMBODIMENTS

An inkjet recording apparatus according to one or more embodiments of the present disclosure will now be described with reference to the drawings. In one or more embodiments described below, a specific example of the inkjet recording apparatus is an inkjet printer including an ink head that ejects ink droplets for image formation onto a wide and long recording medium. The inkjet printer may be used for digital textile printing to print images such as letters or patterns on a recording medium including a textile such as woven fabric or knitted fabric. In one or more embodiments of the present disclosure, the inkjet recording apparatus is also used for printing various inkjet images on a recording medium such as a paper sheet or a resin sheet.

### First Embodiment

### Overall Structure of Inkjet Printer

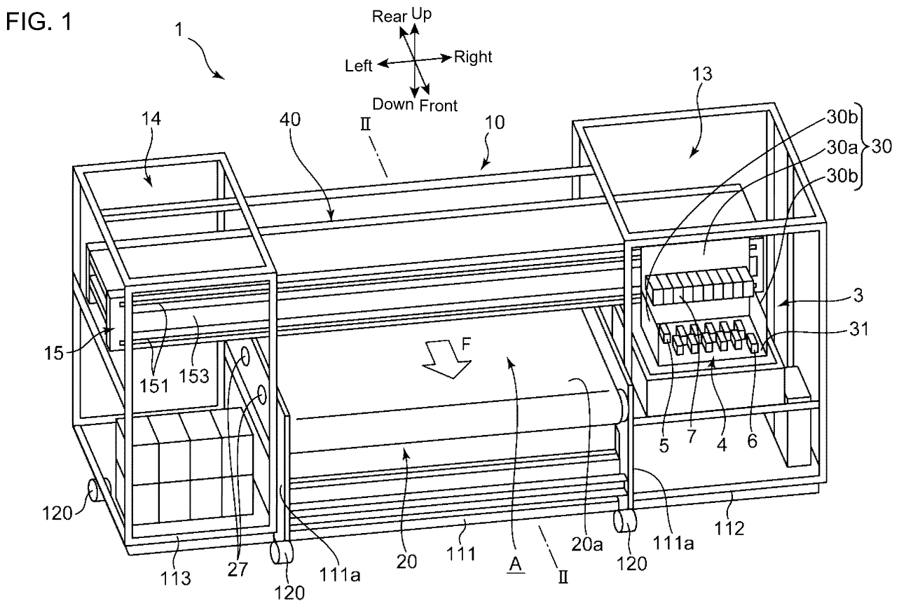

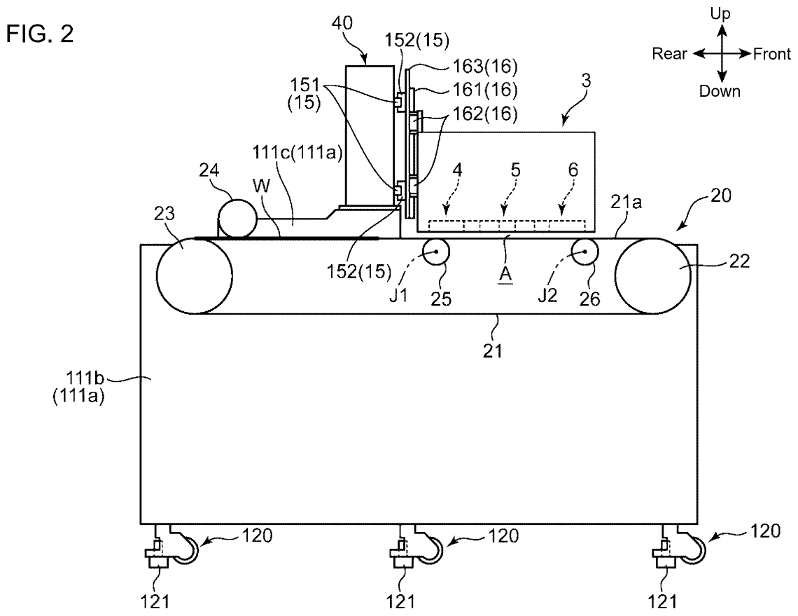

FIG. 1 is a perspective view of an inkjet printer 1 (an example of the inkjet recording apparatus) according to a first embodiment of the present disclosure, illustrating its overall structure. FIG. 2 is a schematic cross-sectional view taken along section line II-II in FIG. 1.

The inkjet printer 1 prints an image on a wide and long workpiece W (recording medium) by inkjet printing. The inkjet printer 1 includes an apparatus frame 10, a workpiece feeder 20 incorporated in the apparatus frame 10, a carriage 3 located above the workpiece feeder 20, and a rail support 40 supported by the apparatus frame 10 from below.

Note that, in the present embodiment, a lateral direction is a main scanning direction S in printing on the workpiece W, and a direction from rear to front is a subscanning direction (corresponding to a feed direction that is a feed direction F of the workpiece W).

The apparatus frame 10 is a frame on which various components of the inkjet printer 1 are mounted. The workpiece feeder 20 is an assembly that intermittently feeds (transports) the workpiece W to move the workpiece W in the feed direction F from rear to front in a printing area in which an inkjet printing process is performed. The carriage 3 carries ink heads 4, a pretreatment head 5, a post-treatment head 6, and subtanks 7, and reciprocates in the main scanning direction S (lateral direction) intersecting with (orthogonal to) the feed direction F of the workpiece W during the inkjet printing process.

The apparatus frame 10 includes a center frame 111, a right frame 112, and a left frame 113. The center frame 111 is a frame on which various components of the inkjet printer 1 are mounted and has a lateral width corresponding to the workpiece feeder 20. The right frame 112 stands on the right of the center frame 111, and the left frame 113 stands on the left of the center frame 111. A printing area A in which the printing process is performed on the workpiece W is defined between the right frame 112 and the left frame 113.

The center frame 111 includes rectangular pipes (not illustrated) joined into a rectangular cuboid framework, and side plates 111a arranged laterally and facing each other in the lateral direction to serve as right and left side surfaces of the center frame 111. As illustrated in FIG. 2, the laterally arranged side plates 111a each include a side plate body 111b that is a rectangular plate located to cover the left or right side of the rectangular cuboid framework, and a side plate protrusion 111c connected to an upper end of the side plate body 111b and protruding upward from a feed belt 21 (described later). The side plate protrusions 111c fix the rail support 40 described above on their upper end surfaces.

Casters 120 for mobility are attached to a lower surface of the center frame 111 at its four corners at the front-left, front-right, rear-left, and rear-right (two of the casters 120 at the front illustrated in FIG. 1).

A caster 120 for mobility is also attached to a lower surface of the left frame 113 on a middle portion of its left end in the front-rear direction, and a caster 120 for mobility is attached a lower surface of the right frame 112 on a middle portion of its right end in the front-rear direction. One of the casters 120 is illustrated in FIG. 1.

As illustrated in FIG. 2, each of the casters 120 includes an adjusting bolt 121 with its head in contact with the floor surface. An operator moves the inkjet printer 1 to a predetermined position with the casters 120, and then rotates and adjusts the adjusting bolts 121. Each of the frames 111, 112, and 113 can thus have an adjusted height and tilt from the floor surface.

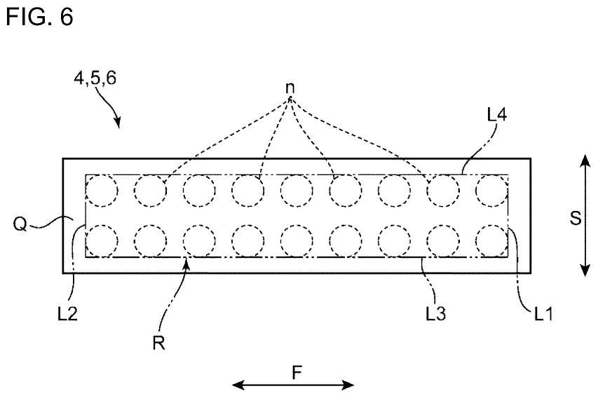

The right frame 112 defines a maintenance area 13. The maintenance area 13 is an area into which the carriage 3 is retracted when the above printing process is not performed. In the maintenance area 13, ejection orifices n (FIG. 6) of the ink heads 4, the pretreatment head 5, and the post-treatment head 6 are, for example, cleaned, purged, or capped. The left frame 113 defines a turn-back area 14 for the carriage 3. The turn-back area 14 is an area for the carriage 3 to enter temporarily after performing main scanning of the printing area A from right to left in the printing process and before performing main scanning in the reverse direction.

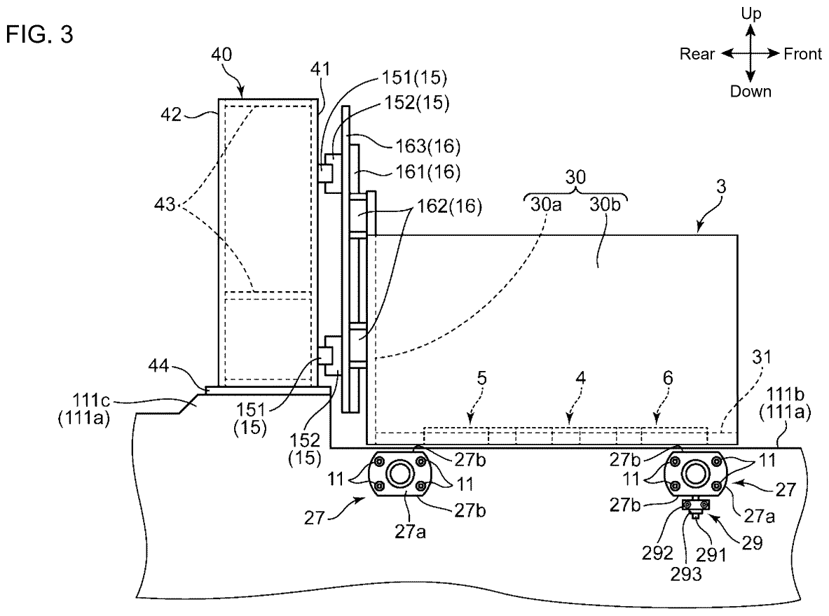

FIG. 3 is an enlarged side view of a carriage mounted portion in the inkjet printer 1 as viewed from the left. As illustrated in the figure, the apparatus frame 10 receives, on its upper portion with the rail support 40, a lateral guide assembly 15 for guiding the carriage 3 to reciprocate in the lateral direction. The carriage 3 is attached to the lateral guide assembly 15 with a vertical guide assembly 16.

The vertical guide assembly 16 includes a pair of guide rails 161 (one is illustrated in FIG. 3) extending in the vertical direction and spaced laterally from each other, sliders 162 engaged with the respective guide rails 161 in a vertically movable manner, and a base plate 163 to which the pair of guide rails 161 are fixed. Each of the guide rails 161 includes two sliders 162. The base plate 163 is a rectangular plate having substantially the same lateral width as the carriage 3. The base plate 163 is fixed to sliders 152 (described later) in the lateral guide assembly 15.

The lateral guide assembly 15 is fixed to a back surface (rear side surface) of the base plate 163 and holds the carriage 3 with the base plate 163. The lateral guide assembly 15 holds the carriage in a manner movable in the main scanning direction S (lateral direction).

More specifically, the lateral guide assembly 15 includes a pair of guide rails 151 extending in the lateral direction and spaced vertically from each other, and the sliders 152 engaged with the respective guide rails 151 in a laterally movable manner. The guide rails 151 extend, through the center frame 111 and the left and right frames 112 and 113, across an entire portion of the inkjet printer 1 in the lateral direction (refer to FIG. 1). Each of the guide rails 151 is engaged with two sliders 152. The sliders 152 are attached to the base plate 163 in the vertical guide assembly 16 on their front surfaces (surfaces on the right in FIG. 2). As described above, the base plate 163 holds the carriage 3 in a vertically movable manner with the guide rails 161 and the sliders 162.

The lateral guide assembly 15 receives a timing belt 153 (illustrated in FIG. 1 alone) rotatable in the lateral direction (main scanning direction S). The timing belt 153 is an endless belt fixed to the base plate 163. The base plate 163, while being guided by the pair of guide rails 151, moves in the left direction or the right direction as the timing belt 153 rotates in the left direction or the right direction. The timing belt 153 is rotated by a carriage drive including a motor and other components. The carriage drive may be driven and controlled based on an operation program prestored in a controller (not illustrated).

Structure of Rail Support As illustrated in FIG. 3, the rail support 40 supports the pair of guide rails 151 in the lateral guide assembly 15 and is located across the upper end surfaces of the laterally arranged side plates 111a (more specifically, the side plate protrusions 111c of the side plates 111a) of the center frame 111.

The rail support 40 includes a front side plate 41 to which the pair of guide rails 151 are fastened, a rear side plate 42 located behind the front side plate 41 with a space, two connecting plates 43 arranged vertically and connecting the front side plate 41 and the rear side plate 42, and seats 44 arranged laterally and supporting the front side plate 41 and the rear side plate 42 at their lower ends. The two ends of the laterally arranged seats 44 each receive an adjusting bolt (not illustrated) with the head in contact with the upper end surface of the corresponding side plate 111a. The tilt of the rail support 40 is adjustable by rotating the adjusting bolts.

### Structure of Workpiece Feeder

Referring back to FIG. 2, the structure of the workpiece feeder 20 will now be described. The workpiece feeder 20 includes the feed belt 21, a drive roller 22, a follower roller 23, a feed roller 24, an upstream support roller 25, and a downstream support roller 26.

The feed belt 21 is wound around the drive roller 22 and the follower roller 23 in a manner rotatable in the front-rear direction. The upper surface of the feed belt 21 serves as a feeding surface 21a for feeding the workpiece W (recording medium). The feed belt 21 rotates in the front-rear direction to feed the workpiece W to the printing area A.

The drive roller 22 and the follower roller 23 extend in the lateral direction and are spaced from each other in the front-rear direction. In the present example, the drive roller 22 is located at a front end of the center frame 111, and the follower roller 23 is located at a rear end of the center frame 111. Each of the drive roller 22 and the follower roller 23 is rotatable with both ends supported by the laterally arranged side plates 111a (more specifically, the side plate bodies 111b of the side plates 111a) of the center frame 111. The drive roller 22 is driven by a motor (not illustrated) and rotates the feed belt 21. The follower roller 23 rotates with the rotation of the feed belt 21 while applying tension to the feed belt 21 to reduce slack.

The feed roller 24 is located slightly frontward from the follower roller 23 and is in contact with the feeding surface 21a (upper surface) of the feed belt 21. The two ends of the feed roller 24 are rotatably supported by the laterally arranged side plates 111a (more specifically, the side plate protrusions 111c of the side plates 111a) of the center frame 111.

A workpiece feeding assembly (not illustrated) is located upstream (in this example, rearward) from the feed roller 24. The workpiece W fed from the workpiece feeding assembly is held between the feed roller 24 and the feed belt 21 and unwound downstream (in this example, frontward) by the feed roller 24. The unwound workpiece W moves from upstream to downstream as the feed belt 21 rotates, and is fed to the printing area A (image formation position) facing the carriage 3.

The printing area A is located between the drive roller 22 and the follower roller 23 in an area near the front end in a plan view. The upstream support roller 25 and the downstream support roller 26, located between the drive roller 22 and the follower roller 23, extend in the lateral direction and are spaced from each other in the front-rear direction.

The upstream support roller 25 and the downstream support roller 26, located below the printing area A, support a lower surface of the feed belt 21 in an inner circumference of the belt. The upstream support roller 25 and the downstream support roller 26 are both rotatably supported by the laterally arranged side plates 111a (more specifically, the side plate bodies 111b of the side plates 111a) of the center frame 111.

The upper ends of the upstream support roller 25 and the downstream support roller 26 are at the same height and slightly upward from the upper ends of the drive roller 22 and the follower roller 23. This increases the tension in the portion of the feed belt 21 between the upstream support roller 25 and the downstream support roller 26 (inter-roller area U described later), and thus can reduce the slack in the feed belt 21.

As illustrated in FIG. 3, the upstream support roller 25 and the downstream support roller 26 each have two ends supported by bearings (not illustrated) held by bearing holders 27. Each of the bearing holders 27 is fixed to the laterally arranged side plates 111a of the center frame 111 with four bolts 11.

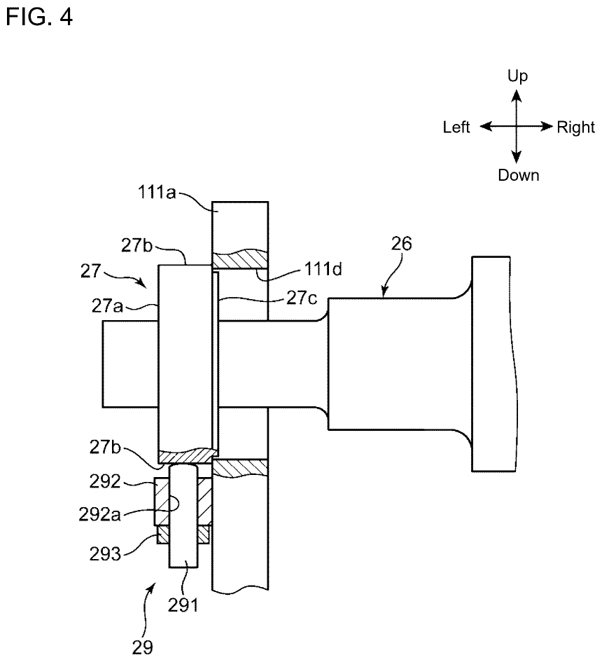

FIG. 4 is a side view of a support structure of the downstream support roller 26 at the left end, including a partial section. As illustrated in this figure, the bearing holder 27 includes a cylindrical holder body 27a with the bearing fitted to an inner circumferential surface of the cylindrical holder body 27a, and a socket 27c protruding from an end surface of the holder body 27a in a thickness direction.

The holder body 27a includes the bearing fitted to the inner circumferential surface. The socket 27c is fitted in a through-hole 111d in the side plate 111a of the center frame 111 in a manner slightly movable (e.g., about 1 to 2 mm) in the vertical direction. The through-hole 111d is an elongated hole slightly elongated in the vertical direction.

The holder body 27a includes, at its upper and lower ends, flat surfaces 27b formed by D-shape cutouts as viewed in an axial direction. The lower one of the flat surfaces 27b is used as a contact surface that is in contact with a set screw 291 in a roller tilt adjuster 29 (described later).

In this example, roller tilt adjusters 29 are provided for the downstream support roller 26 alone that is closer to the front of the inkjet printer 1 between the upstream support roller 25 and the downstream support roller 26.

The roller tilt adjusters 29 each includes one of set screws 291 located below the bearing holders 27 at the left and the right (the bearing holder 27 at the left alone is illustrated in FIG. 4), an adjustment block 292 into which the set screw 291 is screwed, and a fixing nut 293 for fixing the set screw 291. The tilt of the downstream support roller 26 in a height direction (vertical direction) is adjustable by adjusting the vertical position of the bearing holder 27 using the set screws 291. The roller tilt adjusters 29 each correspond to an adjuster configured to adjust parallelism between the upstream support roller 25 and the downstream support roller 26.

More specifically, the adjustment block 292 is bolted to an outer side surface of each of the laterally arranged side plates 111a. The adjustment block 292 includes a screw hole 292a extending vertically. The set screw 291 is screwed into the screw hole 292a and extends vertically through the adjustment block 292. As described above, the set screw 291 includes an upper end surface in contact with the lower one of the flat surfaces 27b of the bearing holder 27. When the operator loosens the fixing nut 293 and rotates the set screw 291, the corresponding bearing holder 27 moves upward or downward following the position of the upper end of the set screw 291. When the operator adjusts the vertical positions of the left and right bearing holders 27 holding the two ends of the downstream support roller 26, the tilt of the downstream support roller 26 can be adjusted in the height direction (vertical direction).

### Structure of Carriage

The structure of the carriage 3 will now be described with reference to FIGS. 1 to 3. In the printing process, the carriage 3 is supported by the vertical guide assembly 16 at a predetermined height and reciprocates along the guide rails 151 in the lateral guide assembly 15 in the main scanning direction S (the left-right direction in the present embodiment) intersecting with (perpendicular to, in the present embodiment) the feed direction F.

More specifically, the carriage 3 includes a carriage body frame 30 and a head support plate 31 connected to the carriage body frame 30. The head support plate 31 receives the ink heads 4, the pretreatment head 5, and the post-treatment head 6 on its upper surface. Note that the carriage body frame 30 and the head support plate 31 may be integral with each other or may be separate components.

The carriage body frame 30 includes a rectangular vertical plate 30a fixed to the sliders 162 in the vertical guide assembly 16, and laterally arranged side plates 30b connected to the left and right ends of the vertical plate 30a. The carriage body frame 30 has an angular U-shape that is open frontward as viewed in plan.

The head support plate 31 holds the heads 4 to 6 described above and covers the lower end of the carriage body frame 30.

### Structure of Heads and Subtanks

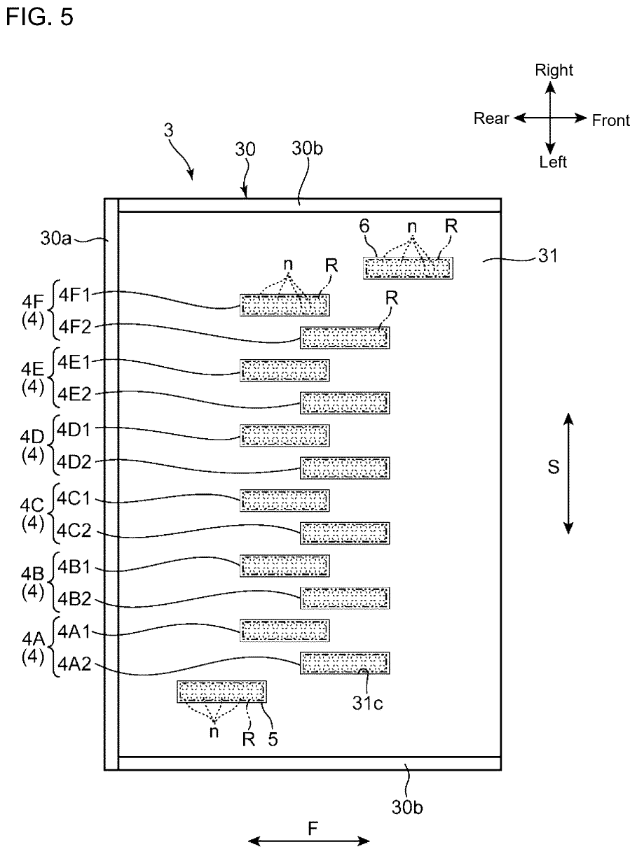

FIG. 5 is a plan view of the heads 4 to 6 arranged on the upper surface of the head support plate 31 in the carriage 3. FIG. 6 is a plan view of an ejection surface Q of the head 4, 5, or 6.

As illustrated in FIG. 5, the head support plate 31 receives, on its upper surface, a head group including multiple ink heads 4 that eject ink droplets for image formation onto the workpiece W, and the pretreatment head 5 and the post-treatment head 6 that eject noncolor-developing treatment liquid droplets.

The pretreatment head 5, the ink heads 4, and the post-treatment head 6 are arranged in this order from upstream to downstream in the feed direction F.

The heads 4 to 6 have a rectangular prism shape elongated in the front-rear direction as viewed in plan, and have the same structure. More specifically, each of the heads 4 to 6 includes many (multiple) ejection orifices n (nozzles) and an ink channel (not illustrated) that guides a liquid to be ejected to the ejection orifices n. The ejection orifices n eject droplets of the liquid to be ejected by, for example, piezoelectric ejection using piezoelectric elements or thermal ejection using heating elements. As illustrated in FIG. 6, the many ejection orifices n include two ejection orifice rows arranged in the main scanning direction S (lateral direction). Each of the ejection orifice rows includes many (multiple) ejection orifices n aligned at equal intervals in the feed direction F (front-rear direction). The ejection orifices n are open in an ejection surface Q that is an lower end surface of each of the heads 4 to 6. Note that, in the examples described below, the size (e.g., the volume ejected for one pulse cycle of a drive voltage in this example) of a droplet of the liquid to be ejected from each of the ejection orifices n on each of the heads 4 to 6 in a single ejection operation is simply referred to as an “ejected droplet size.”

In one or more embodiments of the present disclosure, an area including the many ejection orifices n on the ejection surface Q is referred to as an ejection area R. The ejection area R is defined by a pair of straight lines (line L1 and L2 in the example in FIG. 6) extending in the main scanning direction S perpendicular to the feed direction F through the outer ends of the outermost ejection orifices n in the feed direction F among the many ejection orifices n, and a pair of straight lines (line L3 and L4 in the example in FIG. 6) extending in the feed direction F orthogonal to the main scanning direction S through the outer ends of outermost ejection orifices n in the main scanning direction S among the many ejection orifices n. In this example, the ejection heads 4 to 6 have the same arrangement and structure (the number, arrangement, diameter, and pitch of orifices) of the ejection orifices n, and thus have the same shape and dimensions of the ejection area R.

Examples of an ink liquid, or a liquid to be ejected from the ink head 4, include a water-based pigment ink liquid containing a water-based solvent, a pigment, and a bonding resin. The multiple ink heads 4 in the present embodiment include a first to sixth ink heads 4A to 4F that eject six different colors of ink liquids. For example, the first ink head 4A ejects orange ink droplets, the second ink head 4B ejects green ink droplets, the third ink head 4C ejects yellow ink droplets, the fourth ink head 4D ejects red ink droplets, the fifth ink head 4E ejects blue ink droplets, and the sixth ink head 4F ejects black ink droplets.

The ink heads 4A to 4F of the respective colors are mounted on the head support plate 31 of the carriage 3 and arranged in the main scanning direction S. The ink heads 4A to 4F of the respective colors each include two heads. For example, the first ink head 4A includes an upstream head 4A1 located upstream in the feed direction F and a downstream head 4A2 located downstream from the upstream head 4A1 and shifted leftward in the main scanning direction S. The same or similar structure applies to the ink heads 4B to 4F of other colors. The upstream heads of the ink heads 4B to 4F are at the same position as the upstream head 4A1 in the feed direction F and aligned in the main scanning direction S in a row. The downstream heads are at the same position as the downstream head 4A2 in the feed direction F and aligned in the main scanning direction S in a row. In this example, the upstream portions of the downstream heads 4A2 to 4F2 are located between the upstream heads 4A1 to 4F1. In other words, the ink heads 4 are arranged in a staggered manner on the upper surface of the head support plate 31. The ink heads 4 are thus arranged with a high density in the feed direction F, and the carriage 3 can be smaller in the feed direction F.

The pretreatment head 5 and the post-treatment head 6 are at positions different from the positions of the ink heads 4 in the feed direction F.

In the example in FIG. 5, the single pretreatment head 5 is located leftward from the left end of the row of the upstream ink heads (more specifically, the upstream ink heads 4A1 to 4F1). The pretreatment head 5 is upstream from the ink heads 4 in the feed direction F. In other words, the pretreatment head 5 is located with the center of the ejection area R in the feed direction F located upstream from the center of the ejection area R in each of the upstream heads 4A1 to 4F1 in the feed direction F. The downstream portion of the pretreatment head 5 overlaps the row of the upstream ink heads (more specifically, the upstream heads 4A1 to 4F1) in the feed direction F.

In the same or a similar manner, in the example in FIG. 5, the single post-treatment head 6 is located rightward from the right end of the row of the downstream ink heads (more specifically, the downstream heads 4A2 to 4F2). The post-treatment head 6 is downstream from the ink heads 4 in the feed direction F. In other words, the post-treatment head 6 is located with the center of the ejection area R in the feed direction F located downstream from the center of the ejection area R in each of the downstream heads 4A2 to 4F2 in the feed direction F. The upstream portion of the post-treatment head 6 overlaps the row of the downstream ink heads (more specifically, the downstream heads 4A2 to 4F2) in the feed direction F.

The pretreatment head 5 ejects droplets of a pretreatment liquid (liquid to be ejected) for a predetermined pretreatment for the workpiece W. The droplets of the pretreatment liquid are ejected from the pretreatment head 5 to an area of the workpiece W on which no ink liquid has been ejected from the ink heads 4. The pretreatment liquid is a noncolor-developing treatment liquid that develops no color on the workpiece W, and improves, for example, fixation of ink droplets on the workpiece W or facilitates agglomeration of ink pigments. Examples of the pretreatment liquid include a treatment liquid of a solvent containing a bonding resin and a treatment liquid of a solvent containing a positively charged cationic resin.

The post-treatment head 6 ejects droplets of a post-treatment liquid (liquid to be ejected) for a predetermined post-treatment for the workpiece W to which ink droplets are applied. The post-treatment liquid is ejected from the post-treatment head 6 to an area of the workpiece W on which ink droplets have been ejected from the ink heads 4. The post-treatment liquid is also a noncolor-developing treatment liquid that develops no color on the workpiece W. The post-treatment liquid improves the fixation and the toughness (durability against rubbing or scratching) of an ink image printed on the workpiece W by the ink heads 4. Examples of the post-treatment liquid include a silicone treatment liquid.

The noncolor-developing treatment liquid refers to a liquid that is not perceptible as having developed a color to the naked eye when printed on a recording medium alone. The color includes colors with zero saturation, such as black, white, and gray. Although the noncolor-developing treatment liquid is basically a transparent liquid, a liter of treatment liquid in a liquid state may appear, for example, slightly white or another color. Such a faint color is not perceptible as having developed a color to the naked eye when printed on a recording medium alone. Note that, although some types of treatment liquids printed alone on the recording medium may cause a change such as adding gloss to the recording medium, such a change is not referred to as developing a color.

In the present embodiment, the pretreatment liquid and the post-treatment liquid may be ejected substantially across the surface of the workpiece W, or may be selectively ejected based on an image to be printed in the same manner as or a similar manner to the ink liquid.

Selective ejection of the pretreatment liquid and the post-treatment liquid will now be described. As described above, droplets of the pretreatment liquid, the ink, and the post-treatment liquid are ejected in this order on an area of the workpiece W on which colors are to be printed based on an image. In this case, the ink droplets may have one color or multiple colors. For an area on which no color is to be printed, or in other words, an area on which no ink droplets are ejected, no pretreatment liquid or no post-treatment liquid is basically ejected.

The head support plate 31 includes openings 31c (refer to FIG. 5) at positions of the heads 4 to 6. The head support plate 31 receives the ink heads 4, the pretreatment head 5, and the post-treatment head 6 fitted into the respective openings 31c. The ejection surfaces Q (refer to FIG. 6 described later) of the heads 4 to 6 are exposed through the openings 31c. The ejection surfaces Q exposed through the openings 31a face the feeding surface 21a of the feed belt 21.

The subtanks 7 (illustrated in FIG. 1 alone) are supported by the carriage 3 with a holding frame (not illustrated) above the heads 4, 5, and 6. The subtanks 7 correspond to the respective heads 4, 5, and 6. Each of the subtanks 7 receives supply of the ink or the treatment liquid from a cartridge or a main tank (not illustrated) storing the ink or the treatment liquid, and supplies the ink or the treatment liquid to the corresponding head 4, 5, or 6. Each of the subtanks 7 is connected to the corresponding head 4, 5, and 6 with a pipe (not illustrated).

Printing Method The method of printing performed by the inkjet printer 1 according to the present embodiment will now be described. Note that the inkjet printer 1 performs the printing process on the workpiece W by serial printing. For a wide workpiece W, the workpiece W cannot undergo printing while being fed continuously. With serial printing, the carriage 3 carrying the ink heads 4 of the respective colors repeatedly reciprocates in the main scanning direction S while the workpiece W is intermittently fed in the feed direction F. In this example, the pretreatment head 5 ejects droplets of the pretreatment liquid, the ink heads 4 eject droplets of the ink liquids, and the post-treatment head 6 ejects droplets of the post-treatment liquid while the carriage 3 is both outgoing and returning. The printing process can thus be performed both during outgoing and return travels. The printing operation can be performed both during outgoing and return travels because the pretreatment head 5 and the post-treatment head 6 are shifted in the feed direction F relative to the ink heads 4. When the carriage 3 includes the pretreatment head 5, the ink heads 4, and the post-treatment head 6 aligned in a row in this order in the main scanning direction S, a printing process with which the pretreatment liquid and the post-treatment liquid can be applied in the intended order is performed either in the outgoing travel or in the return travel. The printing process can be performed in both directions when both the pretreatment head 5 and the post-treatment head 6 are located on each of two sides of an array of the ink heads 4. This increases the width of the carriage 3 in the main scanning direction S. Such an arrangement is not used in the present embodiment, and the width of the carriage 3 can thus be smaller in the main scanning direction S.

As described above, in the inkjet printer 1 that is an all-in-one printer including the ink heads 4, the pretreatment head 5, and the post-treatment head 6 mounted on the single carriage 3, the ejected droplet size (in this example, the volume of a droplet of the liquid to be ejected from each of the ejection orifices n in a single ejection operation) may be set to different volumes based on, for example, the intended print image texture. In the present embodiment, the ejected droplet size (volume) is smaller for the post-treatment head 6 than for the pretreatment head 5. More specifically, in this example, when the ejected droplet size for the ink head 4 is X (pl), the ejected droplet size for the pretreatment head 5 is set to the same size (=X (pl)) as the ejected droplet size for the ink head 4, and the ejected droplet size for the post-treatment head 6 is set to half the size (=X/2 (pl)). Note that the ejected droplet size for each of the heads 4 to 6 described above is an example and is not limited to this volume.

As in this example, when the ejected droplet size for the post-treatment head 6 is smaller than the ejected droplet size for the pretreatment head 5, the droplet ejected from the pretreatment head 5 and the droplet ejected from the post-treatment head 6 may spread differently after landing on the print surface of the workpiece W. This may lower the quality of printed images. In this example, however, the upstream support roller 25 and the downstream support roller 26 are arranged in a specifically designed manner. This reduces deterioration in the quality of printed images resulting from the difference in the ejected droplet size between the pretreatment head 5 and the post-treatment head 6.

### Positions of Upstream Support Roller and Downstream Support Roller

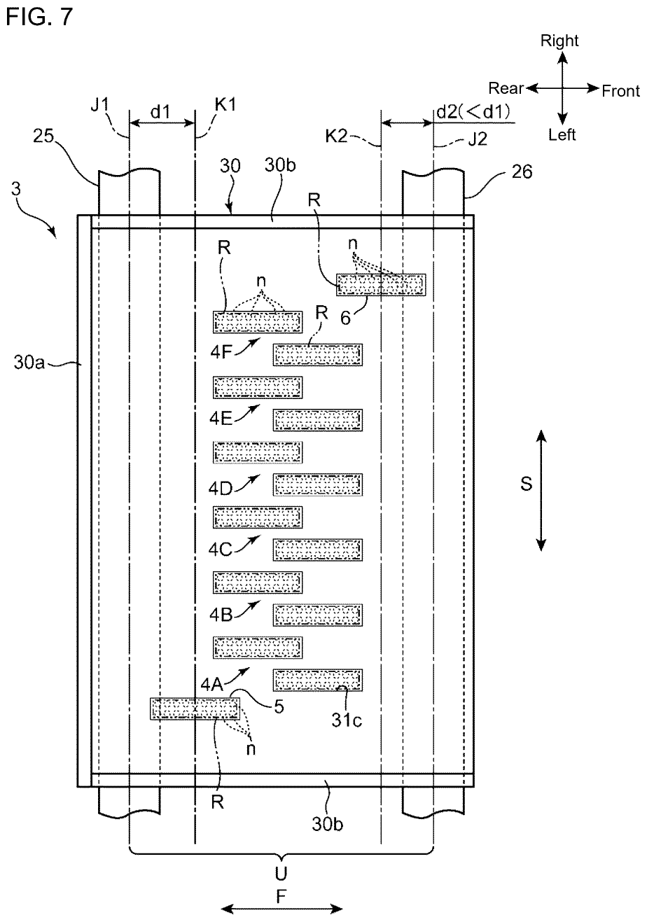

FIG. 7 is a plan view of the carriage 3 as viewed from above, illustrating the arrangement of the upstream support roller 25 and the downstream support roller 26.

In this figure, a line J1 indicates an axis of the upstream support roller 25, and the line J2 indicates an axis of the downstream support roller 26. A line K1 indicates a center line of the ejection area R in the pretreatment head 5 in the feed direction F (more specifically, a line extending in the main scanning direction S through the center of the ejection area R in the feed direction F). A line K2 indicates a center line of the ejection area R in the post-treatment head 6 in the feed direction F (more specifically, a line extending in the main scanning direction S through the center of the ejection area R in the feed direction F).

The upstream support roller 25 and the downstream support roller 26 are arranged to allow the ejection area R in the pretreatment head 5, the ejection areas R in the ink heads 4, and the ejection area R in the post-treatment head 6 to be entirely located (or accommodated) in the inter-roller area U in a plan view (as viewed in the height direction perpendicular to the feeding surface 21a of the feed belt 21). The inter-roller area U is between contact lines on the feed belt 21 (two straight lines aligned with the axes J1 and J2 in a plan view) in contact with the two support rollers 25 and 26.

In other words, the upstream support roller 25 is located with the axis J1 located upstream from the center line K1 of the ejection area R in the pretreatment head 5 in the feed direction F. The downstream support roller 26 is located with the axis J2 located downstream from the center line K2 of the ejection area R in the post-treatment head 6 in the feed direction F.

A distance in the feed direction F between the center line K1 of the ejection area R in the pretreatment head 5 and the axis J1 of the upstream support roller 25 is referred to as a first reference distance d1. A distance in the feed direction F between the center line K2 of the ejection area R in the post-treatment head 6 and the axis J2 of the downstream support roller 26 is referred to as a second reference distance d2. In this case, d2<d1. In other words, the reference distance for the post-treatment head 6 is shorter than the reference distance for the pretreatment head 5. Note that a reference distance refers to a distance from each of the treatment heads 5 and 6 to the nearer one of the two support rollers 25 and 26. In this example, the distance ratio H (=d2/d1) that is the second reference distance d2 (the reference distance for the post-treatment head 6) divided by the first reference distance d1 (the reference distance for the pretreatment head 5) is, for example, within the range of 0.85 to 0.90.

### Operational Effects of First Embodiment

As described above, the inkjet printer 1 according to the present embodiment includes the upstream support roller 25 and the downstream support roller 26 aligned between the drive roller 22 and the follower roller 23 in the feed direction F from the upstream to downstream and supporting the feed belt 21 from inside the belt.

In this structure, the upstream support roller 25 and the downstream support roller 26 support the feed belt 21 from below (inside the belt). This reduces flapping of the feed belt 21 between the drive roller 22 and the follower roller 23 and can improve the quality of printed images.

The upstream support roller 25 and the downstream support roller 26 may be located closer to the two ends of the printing area A to improve the quality of printed images. However, when the size of droplets (volume of droplets in this example) of a liquid to be ejected differs between the pretreatment head 5 and the post-treatment head 6, relatively smaller droplets may not land at their target positions. This lowers the quality of printed images.

In the present embodiment, however, the positions of the upstream support roller 25 and the downstream support roller 26 in the feed direction F are predetermined to cause the reference distance (one of the first reference distance d1 or the second reference distance d2, or the second reference distance d2 in the present embodiment) for either the pretreatment head 5 or the post-treatment head 6 with a smaller ejected droplet size (the post-treatment head 6 in the present embodiment) to be shorter than the reference distance (the other of the first reference distance d1 or the second reference distance d2, or the first reference distance dl in the present embodiment) for the head with a larger ejected droplet size. In other words, the post-treatment head 6 has a smaller ejected droplet size than the pretreatment head 5 in the present embodiment. Thus, the second reference distance d2 is shorter than the first reference distance d1.

This structure can reduce deterioration in the quality of printed images resulting from the difference in the ejected droplet size between the pretreatment head 5 and the post-treatment head 6.

In other words, the inventors have reached ideas (i) and (ii) described below through intensive research. More specifically, (i) when the ejection orifices n of each of the heads 4 to 6 have a small ejected droplet size (when a droplet has a small volume), the droplet landing on the print surface of the workpiece W is less likely to spread (the droplet spreads by a smaller degree in diameter when landing and bursting). The ejected droplet landing with any deviation from its target droplet landing position thus fails to spread across the entire portion of the target dot area of the ejected droplet. (ii) A structure with a smaller ejected droplet size is allowed to have a smaller deviation in the droplet landing position compared with a structure with a larger ejected droplet size. The inventors have applied the above ideas to the inkjet printer 1 according to the present embodiment, and have reached a conclusion that the allowable deviation in the droplet landing position is smaller for the post-treatment head 6 with a smaller ejected droplet size (smaller ejected droplet volume) than for the pretreatment head 5. The inventors aiming to reduce the deviation in the droplet landing position of a droplet ejected from the post-treatment head 6 thus have set the second reference distance d2 for the post-treatment head 6 to be shorter than the first reference distance d1 for the pretreatment head 5 as described above. Thus, the position of the contact line of the downstream support roller 26 near the post-treatment head 6 and the feed belt 21 (or in other words, the position at which the feed belt 21 is less likely to slack) is as close as possible to an area of the feed belt 21 below the ejection area R in the post-treatment head 6. This reduces the likelihood of the feed belt 21 slacking or flapping below the post-treatment head 6.

Although the post-treatment head 6 has a small ejected droplet size and allowable deviations in the droplet landing positions for ejected droplets from the post-treatment head 6 are limited within a narrow range as in the present embodiment, the post-treatment head 6 can cause droplets (of the post-treatment liquid) to land within the allowable range. The post-treatment head 6 thus achieves dot formation accuracy (the accuracy of positions of dots formed upon the landing of ejected droplets) that is not lower than the dot formation accuracy achieved by the pretreatment head 5. In this manner, the structure according to the present embodiment reduces the difference in the dot formation accuracy resulting from the difference in the ejected droplet size between the pretreatment head 5 and the post-treatment head 6, and thus can eventually reduce deterioration in the quality of printed images.

In the present embodiment, the positions of the two support rollers 25 and 26 in the feed direction F are set to allow the ejection area R in the pretreatment head 5, the ejection areas R in the ink heads 4, and the ejection area R in the post-treatment head 6 to be entirely located, as viewed in plan (as viewed in the height direction perpendicular to the feeding surface 21a of the feed belt 21), in the inter-roller area U between the contact lines on the feed belt 21 (two straight lines aligned with the axes J1 and J2 of the support rollers 25 and 26 in a plan view) in contact with the upstream support roller 25 and the downstream support roller 26.

This structure can improve the quality of printed images as much as possible. In other words, the upstream support roller 25 and the downstream support roller 26 apply sufficient tension on the feed belt 21. Thus, the inter-roller area U of the feed belt 21 is less likely to slack or flap. With the ejection area R in the pretreatment head 5, the ejection areas R in the ink heads 4, and the ejection area R in the post-treatment head 6 all located in the inter-roller area U as viewed in plan, the droplets ejected from the heads 4 to 6 can land on the workpiece W on the inter-roller area U with reduced slacking or flapping. This can further reduce deterioration in the quality of printed images resulting from slacking or flapping of the feed belt 21.

In the present embodiment, the inkjet printer 1 includes the roller tilt adjuster 29 for adjusting parallelism between the upstream support roller 25 and the downstream support roller 26.

The operator can thus adjust the parallelism between the inter-roller area U of the feed belt 21 and the ejection surfaces Q of the heads 4 to 6 mounted on the carriage 3 to have predetermined parallelism by adjusting the parallelism between the upstream support roller 25 and the downstream support roller 26 using the roller tilt adjuster 29. This can maintain a constant distance between the ejection surface Q of each of the heads 4 to 6 and the workpiece W on the feed belt 21 independently of the position of the carriage 3 in the main scanning direction and can reduce variations in the droplet landing positions of droplets ejected from each of the heads 4 to 6, eventually improving the quality of printed images.

### Variation of First Embodiment

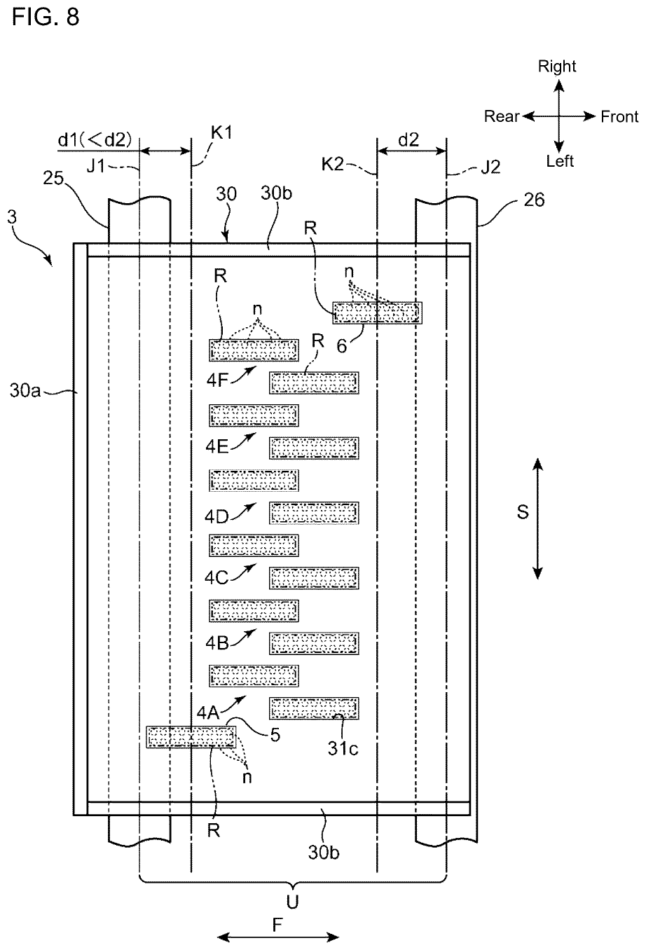

FIG. 8 is a diagram illustrating a variation of the first embodiment, corresponding to FIG. 7. The variation differs from the first embodiment in the relationship between the ejected droplet size for the pretreatment head 5 and the ejected droplet size for the post-treatment head 6 and in the relationship between the first reference distance d1 for the pretreatment head 5 and the second reference distance d2 for the post-treatment head 6. Note that the structure other than above is the same as or similar to the structure in the first embodiment. The same components as in the first embodiment are given the same reference numerals and will not be described below in detail.

In other words, the pretreatment head 5 has a smaller ejected droplet size than the post-treatment head 6 in the present variation. In this example, when the ejected droplet size for the ink head 4 is X (pl), the ejected droplet size for the pretreatment head 5 is set to half the size (=X/2 (pl)), and the ejected droplet size for the post-treatment head 6 is set to the same size (=X (pl)) as the ejected droplet size for the ink head 4. Note that the ejected droplet sizes are set as examples and are not limited to these examples.

In the present variation, the first reference distance d1 (the distance in the feed direction F between the center line K1 of the ejection area R in the pretreatment head 5 and the axis J1 of the upstream support roller 25) is shorter than the second reference distance d2 (the distance in the feed direction F between the center line K2 of the ejection area R in the post-treatment head 6 and the axis J2 of the downstream support roller 26), or in other words, d1<d2, as illustrated in FIG. 8. In other words, the pretreatment head 5 has a smaller reference distance than the post-treatment head 6. In this example, the distance ratio H (=d1/d2) that is the first reference distance d1, or the reference distance for the pretreatment head 5, divided by the second reference distance d2, or the reference distance for the post-treatment head 6, is, for example, within the range of 0.85 to 0.90.

### Operational Effects of Variation of First Embodiment

In the present variation, the pretreatment head 5 and the post-treatment head 6 have different ejected droplet sizes from each other as described above. The upstream support roller 25 and the downstream support roller 26 are arranged in the feed direction F to cause the reference distance (one of the first reference distance d1 or the second reference distance d2, or the first reference distance d1 in this example) for either the pretreatment head 5 or the post-treatment head 6 with a smaller ejected droplet size (the pretreatment head 5 in this example) to be shorter than the reference distance (the other of the first reference distance d1 or the second reference distance d2, or the second reference distance d2 in this example) for the head with a larger ejected droplet size (the post-treatment head 6 in this example). In other words, the pretreatment head 5 has a smaller ejected droplet size than the post-treatment head 6 in the present embodiment. Thus, the first reference distance d1 is shorter than the second reference distance d2.

In this structure, the position of the contact line of the upstream support roller 25 near the pretreatment head 5 and the feed belt 21 (or in other words, the position at which the feed belt 21 is less likely to slack) is as close as possible to an area of the feed belt 21 below the ejection area R in the pretreatment head 5. This reduces the likelihood of the feed belt 21 slacking or flapping below the pretreatment head 5. Although the pretreatment head 5 has a small ejected droplet size and a narrow range of allowable deviations in the droplet landing positions for the droplets ejected from the pretreatment head 5 as in the present variation, the pretreatment head 5 can cause droplets (of the pretreatment liquid) to land within the allowable range. The pretreatment head 5 thus achieves, on the printable surface of the workpiece W, dot formation accuracy that is not lower than the dot formation accuracy achieved by the post-treatment head 6.

The structure according to the present variation can thus, as in the first embodiment, reduce degradation of the quality of printed images resulting from the difference in the ejected droplet size between the pretreatment head 5 and the post-treatment head 6.

### Second Embodiment

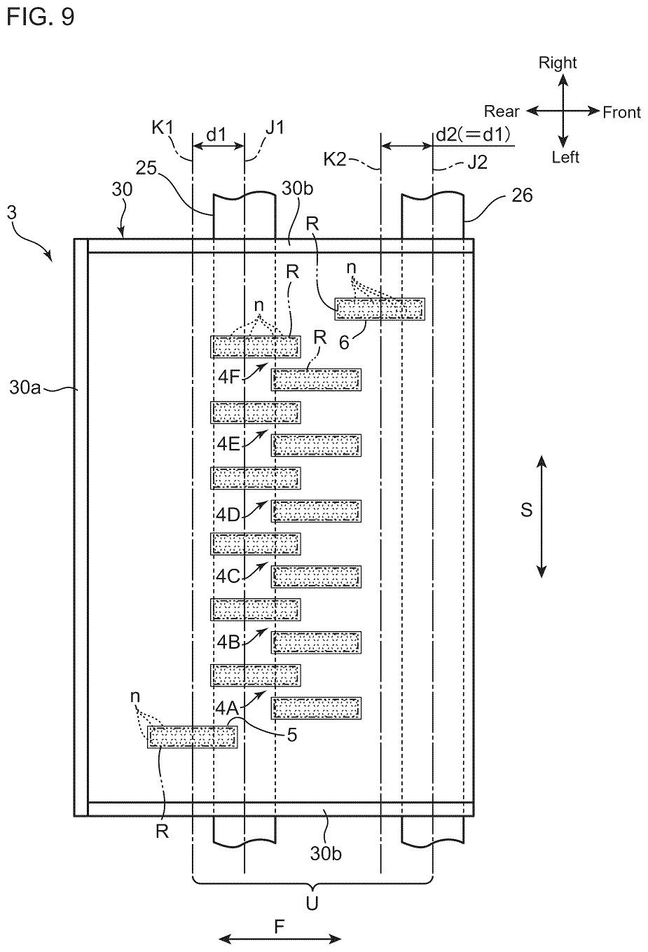

FIG. 9 is a plan view of a second embodiment corresponding to FIG. 7. In the present embodiment, the upstream support roller 25 and the downstream support roller 26 have structures and arrangement different from those in the first embodiment. Note that the structures other than the support rollers are the same as or similar to those in the first embodiment. The same components as in the first embodiment are given the same reference numerals and will not be described below in detail.

In other words, the size of droplets ejected from the post-treatment head 6 is smaller than the size of droplets ejected from the pretreatment head 5 in the present embodiment as in the first embodiment. However, the positions of the upstream support roller 25 and the downstream support roller 26 relative to the heads 4 to 6 are different from those in the first embodiment as described below.

More specifically, in the present embodiment, the positions of the upstream support roller 25 and the downstream support roller 26 in the feed direction F are set to allow the ejection area R in the post-treatment head 6 to be, as viewed in plan (as viewed in the height direction perpendicular to the feeding surface 21a of the feed belt 21), entirely located in the inter-roller area U between the contact lines on the feed belt 21 (two straight lines aligned with the axes J1 and J2 of the support rollers 25 and 26 in a plan view) in contact with the upstream support roller 25 and the downstream support roller 26 and to allow the ejection area R in the pretreatment head 5 to be entirely located outside (upstream in the feed direction F from) the inter-roller area U.

In the present embodiment, the first reference distance d1 for the pretreatment head 5 (the distance between the center line K1 of the ejection area R in the pretreatment head 5 and the axis J1 of the upstream support roller 25) is equal to the second reference distance d2 for the post-treatment head 6 (the distance between the center line K2 of the ejection area R in the post-treatment head 6 and the axis J2 of the downstream support roller 26), or in other words, d1=d2.

### Operational Effects of Second Embodiment

The structure according to the present embodiment, in which the first reference distance d1 for the pretreatment head 5 is equal to the second reference distance d2 for the post-treatment head 6, can reduce deterioration in the quality of printed images resulting from the difference in the size of ejected droplets between the pretreatment head 5 and the post-treatment head 6. In other words, the post-treatment head 6 has a smaller ejected droplet size than the pretreatment head 5 in the present embodiment as in the first embodiment. Thus, the post-treatment head 6 has a narrower allowable range for the droplet landing positions for ejected droplets (in other words, is expected to achieve high accuracy in the droplet landing position). When the post-treatment head 6 expected to achieve such high accuracy in the droplet landing position is located in the inter-roller area U as viewed in plan, the feed belt 21 is less likely to slack or flap below the post-treatment head 6. The post-treatment head 6 can thus achieve the expected high accuracy in the droplet landing position. The pretreatment head 5 is, however, located outside the inter-roller area U in a plan view, and thus has lower accuracy in the droplet landing position for ejected droplets than the post-treatment head 6. In other words, the feed belt 21 outside the inter-roller area U receives a lower tension on the belt than in the inter-roller area U, and is slightly inclined in the feed direction F (due to the upper ends of the support rollers 25 and 26 being slightly higher than the upper ends of the drive roller 22 and the follower roller 23). Thus, the feeding surface 21a may be inclined or slack. The pretreatment head 5 thus performs the printing process on the workpiece W outside the inter-roller area U, and has lower accuracy in the droplet landing position for ejected droplets than the post-treatment head 6. However, as described above, the pretreatment head 5 has a larger ejected droplet size than the post-treatment head 6, and a droplet after landing spreads in a larger area. The pretreatment head 5 is thus expected to have lower accuracy in the droplet landing position. Thus, placing the pretreatment head 5 outside the inter-roller area U in a plan view does not cause deterioration in the quality of printed images.

The structure according to the present embodiment can thus reduce deterioration in the quality of printed images resulting from the difference in the ejected droplet size between the pretreatment head 5 and the post-treatment head 6 in the same manner as or a similar manner to the structure in the first embodiment.

### Variation of Second Embodiment

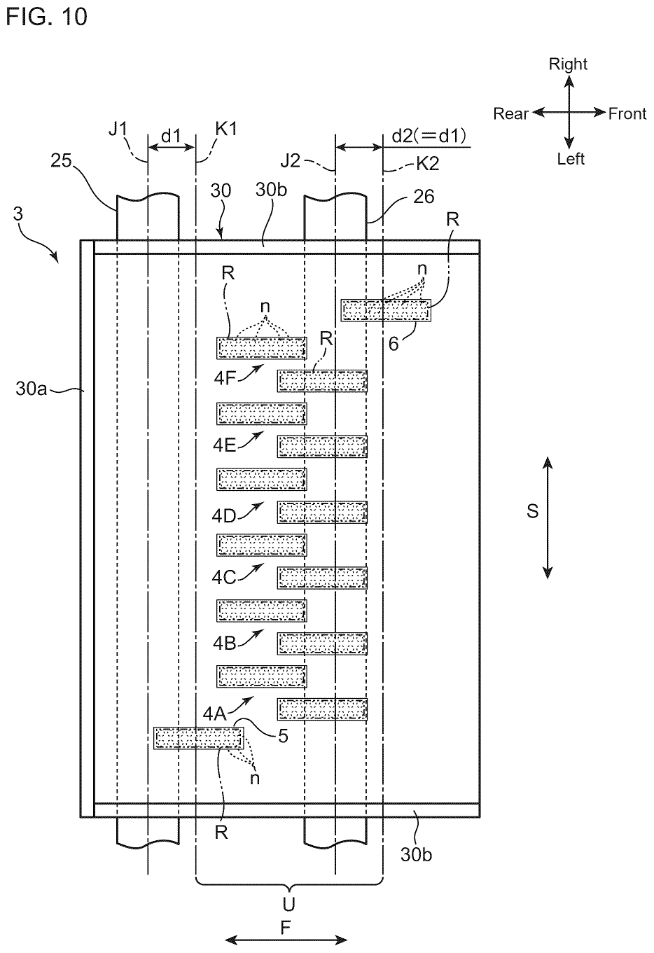

FIG. 10 is a diagram illustrating a variation of the second embodiment, corresponding to FIG. 9. The variation differs from the second embodiment in the relationship between the ejected droplet size for the pretreatment head 5 and the ejected droplet size for the post-treatment head 6 and in the relative positional relationship among the pretreatment head 5, the post-treatment head 6, and the inter-roller area U in the feed direction F. Note that the structure other than the above is the same as or similar to the structure in the second embodiment. The same components as those in the second embodiment are given the same reference numerals and will not be described below in detail.

In other words, the pretreatment head 5 has a smaller ejected droplet size than the post-treatment head 6 in the present variation. In the present variation, when the ejected droplet size for the ink head 4 is X (pl), the ejected droplet size for the pretreatment head 5 is set to half the ejected droplet size for the ink head 4 (=X/2 (pl)), and the ejected droplet size for the post-treatment head 6 is set to the same size (=X (pl)) as the ejected droplet size for the ink head 4. Note that the ejected droplet sizes are set as examples and are not limited to these examples.

In the present variation, the positions of the upstream support roller 25 and the downstream support roller 26 in the feed direction F are set to allow the ejection area R in the pretreatment head 5 to be entirely located in the inter-roller area U and the ejection area R in the post-treatment head 6 to be entirely located outside (downstream in the feed direction F from) the inter-roller area U as viewed in plan (as viewed in the height direction perpendicular to the feeding surface 21a of the feed belt 21) as illustrated in FIG. 10.

In the present variation, the first reference distance d1 for the pretreatment head 5 (in other words, the distance between the center line K1 of the ejection area R in the pretreatment head 5 and the axis J1 of the upstream support roller 25) is equal to the second reference distance d2 for the post-treatment head 6 (the distance between the center line K2 of the ejection area R in the post-treatment head 6 and the axis J2 of the downstream support roller 26) or in other words, d1=d2.

### Operational Effects of Variation of Second Embodiment

In the present variation, the pretreatment head 5 has a smaller ejected droplet size than the post-treatment head 6. A droplet ejected from the pretreatment head 5 spreads in a smaller area than a droplet ejected from the post-treatment head 6, and the pretreatment head 5 is also allowed to have smaller deviations for ejected droplets (in other words, is expected to achieve high accuracy in the droplet landing position). In the present variation, the pretreatment head 5 expected to achieve such high accuracy in the droplet landing position is located, as viewed in plan, in the inter-roller area U in which the feed belt 21 is less likely to slack or flap. The pretreatment head 5 can thus achieve the expected high accuracy in the droplet landing position for ejected droplets. This structure can thus reduce deterioration in the quality of printed images resulting from the difference in the ejected droplet size between the pretreatment head 5 and the post-treatment head 6 in the same manner as or a similar manner to the structure according to the second embodiment.

### Other Embodiments

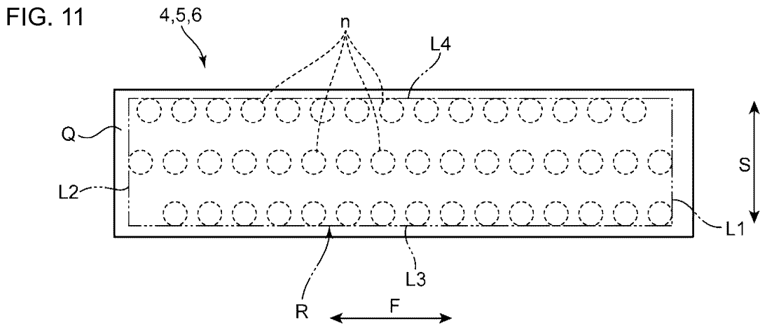

Although the inkjet printer 1 (inkjet recording apparatus) in one or more embodiments of the present disclosure is described above, the present disclosure is not limited to the above embodiments, and may be implemented in, for example, various manners described below.
(1) In the above embodiments and variations, the volume (pl) of the droplet is used as the size of a droplet to identify, of the pretreatment head 5 and the post-treatment head 6, the treatment head that ejects smaller droplets of the liquid to be ejected from the ejection orifice n and the treatment head that ejects larger droplets. However, the size of a droplet is not limited to the above example and may be the mass of a droplet.
(2) In the above embodiments and variations, the ejection orifices n on each of the heads 4 to 6 are two rows of many ejection orifices n (the number of ejection orifices n is the same in each row) arranged regularly in a grid as illustrated in FIG. 6. However, the ejection orifices n are not limited to the above example. For example, the number of ejection orifices n may or may not be the same in all rows as illustrated in FIG. 11, and the ejection orifices n may be arranged in an irregular manner with the ejection orifices n at the two ends in the feed direction F shifted in the feed direction F. In this case as well, the ejection area R indicated by the two-dot-dash lines in FIG. 11 is defined based on the definition of the ejection area R described in the above embodiments.
(3) In the above embodiments and variations, the heads 4 to 6 include the same number of ejection orifices n and have the same arrangement and structure. However, the number, arrangement, and structure of the ejection orifices n may not be limited to the above example and may vary between the heads 4 to 6.
(4) In the second embodiment, the upstream support roller 25 and the downstream support roller 26 are arranged in the feed direction F to allow the ejection area R in the pretreatment head 5 to be entirely located outside (upstream in the feed direction F from) the inter-roller area U as viewed in plan (refer to FIG. 9). However, the ejection area R in the pretreatment head 5 may not be limited to the above example and may be partially or entirely located in the inter-roller area U.
(5) In the above variation of the second embodiment, the upstream support roller 25 and the downstream support roller 26 are arranged in the feed direction F to allow the ejection area R in the post-treatment head 6 to be entirely located outside (downstream in the feed direction F from) the inter-roller area U as viewed in plan (refer to FIG. 10). However, the post-treatment head 6 may not be limited to the above example and may be partially or entirely located in the inter-roller area U.
(6) In the above embodiments and variations, the ink heads 4 are arranged in two rows in the feed direction F. However, the ink heads 4 are not limited to have the above arrangement and may be arranged in a single row or in three or more rows. Although the single pretreatment head 5 and the single post-treatment head 6 are included in the above embodiments and variations, two or more pretreatment heads 5 or two or more post-treatment heads 6 may be arranged in the main scanning direction, or two or more pretreatment heads 5 or two or more post-treatment heads 6 may be arranged in the feed direction F. In the latter case, the pretreatment head 5 and the post-treatment head 6 that are closest to the ink heads 4 in the feed direction F may have the positional relationship with the upstream support roller 25 and the downstream support roller 26 as described above.
(7) In the above embodiments and variations, the ink heads 4, the pretreatment head 5, and the post-treatment head 6 are mounted on the carriage 3 movable in the main scanning direction. However, the ink heads 4, the pretreatment head 5, and the post-treatment head 6 may not be limited to the structure described above and may be mounted on a stationary line head, and the workpiece W alone may be moved in the feed direction relative to the line head.

1. An inkjet recording apparatus, comprising:
a head group including an ink head, a pretreatment head, and a post-treatment head, the ink head including an ejection area through which an ink liquid is ejected, the pretreatment head including an ejection area through which a pretreatment liquid is ejected, the post-treatment head including an ejection area through which a post-treatment liquid is ejected;
a feed belt including a feeding surface facing the ejection areas in the head group with a space between the feeding surface and the ejection areas, the feed belt being rotatable in a feed direction to feed a recording medium on the feeding surface in the feed direction;
a pair of rollers around which the feed belt is wound, the pair of rollers being spaced from each other in the feed direction; and
an upstream support roller and a downstream support roller aligned in the feed direction between the pair of rollers and supporting the feed belt from inside the feed belt,
wherein the pretreatment head, the ink head, and the post-treatment head are arranged in an order of the pretreatment head, the ink head, and the post-treatment head from upstream to downstream in the feed direction, and
one of a first reference distance or a second reference distance for the pretreatment head or the post-treatment head to eject a smaller amount of liquid is shorter than another of the first reference distance or the second reference distance for the pretreatment head or the post-treatment head to eject a larger amount of liquid, where the first reference distance is a distance in the feed direction between a center of the ejection area in the pretreatment head in the feed direction and a position of an axis of the upstream support roller, and the second reference distance is a distance in the feed direction between a center of the ejection area in the post-treatment head in the feed direction and a position of an axis of the downstream support roller.

2. The inkjet recording apparatus according to claim 1, wherein
when viewed in a direction perpendicular to the feeding surface of the feed belt, the ejection area in the pretreatment head, the ejection area in the ink head, and the ejection area in the post-treatment head are entirely located in an inter-roller area on the feed belt between a contact line with the upstream support roller and a contact line with the downstream support roller.

3. The inkjet recording apparatus according to claim 1, further comprising:
an adjuster configured to adjust parallelism between the upstream support roller and the downstream support roller.

4. The inkjet recording apparatus according to claim 3, wherein
the pretreatment head or the post-treatment head to eject a smaller amount of liquid is the post-treatment head.

5. The inkjet recording apparatus according to claim wherein
the pretreatment head or the post-treatment head to eject a smaller amount of liquid is the pretreatment head.

6. An inkjet recording apparatus, comprising:
a head group including an ink head, a pretreatment head, and a post-treatment head, the ink head including an ejection area through which an ink liquid is ejected, the pretreatment head including an ejection area through which a pretreatment liquid is ejected, the post-treatment head including an ejection area through which a post-treatment liquid is ejected;
a feed belt including a feeding surface facing the ejection areas in the head group with a space between the feeding surface and the ejection areas, the feed belt being rotatable in a feed direction to feed a recording medium on the feeding surface in the feed direction;
a pair of rollers around which the feed belt is wound, the pair of rollers being spaced from each other in the feed direction; and
an upstream support roller and a downstream support roller aligned in the feed direction between the pair of rollers and supporting the feed belt from inside the feed belt,
wherein the pretreatment head, the ink head, and the post-treatment head are arranged in an order of the pretreatment head, the ink head, and the post-treatment head from upstream to downstream in the feed direction,
the post-treatment head is configured to eject a smaller amount of liquid than the pretreatment head,
a distance in the feed direction between a center of the ejection area in the pretreatment head in the feed direction and a position of an axis of the upstream support roller is equal to a distance in the feed direction between a center of the ejection area in the post-treatment head in the feed direction and a position of an axis of the downstream support roller, and
when viewed in a direction perpendicular to the feeding surface of the feed belt, the ejection area in the post-treatment head is entirely located in an inter-roller area on the feed belt between a contact line with the upstream support roller and a contact line with the downstream support roller.

7. The inkjet recording apparatus according to claim 6, wherein
when viewed in the direction perpendicular to the feeding surface of the feed belt, the ejection area in the post-treatment head is entirely located in the inter-roller area, and the ejection area in the pretreatment head is at least partially located outside the inter-roller area.

8. An inkjet recording apparatus, comprising:
a head group including an ink head, a pretreatment head, and a post-treatment head, the ink head including an ejection area through which an ink liquid is ejected, the pretreatment head including an ejection area through which a pretreatment liquid is ejected, the post-treatment head including an ejection area through which a post-treatment liquid is ejected;
a feed belt including a feeding surface facing the ejection areas in the head group with a space between the feeding surface and the ejection areas, the feed belt being rotatable in a feed direction to feed a recording medium on the feeding surface in the feed direction;
a pair of rollers around which the feed belt is wound, the pair of rollers being spaced from each other in the feed direction; and
an upstream support roller and a downstream support roller aligned in the feed direction between the pair of rollers and supporting the feed belt from inside the feed belt,
wherein the pretreatment head, the ink head, and the post-treatment head are arranged in an order of the pretreatment head, the ink head, and the post-treatment head from upstream to downstream in the feed direction,
the pretreatment head is configured to eject a smaller amount of liquid than the post-treatment head,
a distance in the feed direction between a center of the ejection area in the pretreatment head in the feed direction and a position of an axis of the upstream support roller is equal to a distance in the feed direction between a center of the ejection area in the post-treatment head in the feed direction and a position of an axis of the downstream support roller, and
when viewed in a direction perpendicular to the feeding surface of the feed belt, the ejection area in the pretreatment head is entirely located in an inter-roller area on the feed belt between a contact line with the upstream support roller and a contact line with the downstream support roller.

9. The inkjet recording apparatus according to claim 8,
wherein
when viewed in a direction perpendicular to the feeding surface of the feed belt, the ejection area in the pretreatment head is entirely located in the inter-roller area, and the ejection area in the post-treatment head is at least partially located outside the inter-roller area.
